(19) United States
(12) Patent Application Publication
(10) Pub. No.: US 2012/0089934 A1
(43) Pub. Date: Apr. 12, 2012

(54) METHODS AND APPARATUS FOR PRESENTING INFORMATION IDENTIFYING RELATIONSHIPS IN A DATABASE

(76) Inventor: Bhargav Senjalia, Dover, NJ (US)

(21) Appl. No.: 13/168,525

(22) Filed: Jun. 24, 2011

Related U.S. Application Data
(60) Provisional application No. 61/391,890, filed on Oct. 11, 2010.

(51) Int. Cl. G06F 3/048; G06F 17/30

(52) U.S. Cl. 715/771

(57) ABSTRACT

A method, apparatus, and non-transitory computer-readable storage medium for presenting information identifying relationships in a database. Entity labels identifying a plurality of different entity types modeled in the database are presented in a user interface. Input identifying one or more selected entity types is received. A plurality of entity instance relationship sets is accessed. Each entity instance relationship set identifies a relationship between entity instances of at least two different entity types. Attribute data of the entity instances identified in only those entity instance relationship sets that identify a relationship between entity instances of the one or more selected entity types are presented, such that attribute data for each unique relationship between entity instances of the one or more selected entity types are presented only once.

### RELATED APPLICATION

This application claims the benefit of provisional patent application Ser. No. 61/391,890, filed Oct. 11, 2010, the disclosure of which is hereby incorporated herein by reference in its entirety.

### FIELD OF THE DISCLOSURE

Embodiments disclosed herein relate to data analysis, and in particular to presenting information identifying entity instances of different entity types that are related to one another.

### BACKGROUND

Databases are used to store information, and are frequently organized based on an abstraction referred to as an “entity.” Each entity models, or represents, a thing that is relatively distinct from another thing. One example is a retailer database, which may be organized based at least in part on a customer entity used to model, or represent, customers of the retailer; a product entity used to model products carried by the retailer; a vendor entity used to model vendors of the retailer; and a store entity used to model various physical retail locations (stores) of the retailer. Each entity typically has a relationship with one or more other entities. Obvious relationships among the above entities might include a relationship between customers and products, e.g., certain customers purchased certain products, and a relationship between vendors and products, e.g., particular products are supplied by certain vendors.

An entity, such as a customer entity, also typically defines attributes which contain data that describe or otherwise relate to the thing being modeled. For example, a customer entity may have a name attribute, an address attribute, and the like. The collection of attribute data that describes the actual thing being modeled is referred to as an instance of the entity, or, for shorthand, an entity instance. There may be many entity instances of each type of entity. Using the above example, the retailer database may include thousands of entity instances of the customer entity type, each entity instance including attribute data associated with a particular customer of the retailer. Typically, each entity instance will include at least one attribute that uniquely identifies a particular entity instance of a particular entity type from every other entity instance of the same entity type. For example, each customer entity instance may include a unique identifier attribute that uniquely identifies a particular customer.

There are frequently relationships among entity instances of different entity types in a database, some of which may be relatively obvious, and some less so. For example, a particular customer entity instance has a relationship with a particular product entity instance if the customer represented by the customer entity instance purchased the product represented by the particular product entity instance. This information may be valuable to the retailer because it provides the retailer with potentially useful information about the customer, such as the fact that the customer may be a country music fan if the product is a country music CD. The particular product entity instance is also related to a particular store entity instance by virtue of the fact that the product was sold by a particular store of the retailer. Note that this latter relationship actually further establishes a relationship between the particular customer entity instance and the particular store entity instance in that the particular customer purchased the country music CD from the particular store. Knowing that the particular customer shops at a particular store may also be useful to the retailer. Consequently, it is not unusual for a database owner to want to know what relationships exist among the entity instances in a database.

Typically, when an individual wants a report identifying the entity instances which are related to one another, another individual—typically a person skilled in the particular database technology used to store the data—must develop a specialized program which extracts this information from the database that contains the entity instances. This can be a time-consuming and expensive process, and requires access to individuals with specialized database skills. Moreover, the resulting software is tailored to generating a report about particular entity types. If a different report that provides information about different entity types is desired, another specialized program must be developed. Accordingly, there is a need for a mechanism that can provide information about relationships between entity instances in a database that does not require modification for each different desired report, and that easily and intuitively presents information identifying relationships between entity instances in the database.

### SUMMARY

Embodiments disclosed herein relate to presenting information identifying relationships between different types of things modeled, or represented, in a database. In particular, each thing represented in the database is represented as a particular type of entity, and the database represents many different entity types, and also typically represents many things of the same entity type. Each thing represented in the database is represented in a data structure referred to as an entity instance. Each entity instance is made up of attribute data that describes aspects of the thing being represented. For example, if the thing being represented is a customer, the attribute data may identify the customer name, the customer address, the customer credit rating, the customer preferences, and the like.

In one embodiment, in response to user selection, attribute data is presented that identifies relationships between entity instances of different entity types. The embodiments herein include a simple and intuitive user interface that receives a selection from a user of any combination of different entity types of a plurality of entity types, and in response, presents information identifying the relationships between the entity instances of the selected entity types.

In particular, in one embodiment, entity names, or labels, that identify a plurality of different entity types that are modeled in a database are presented in the user interface. The user selects one or more of the entity types. A plurality of entity instance relationship sets that identify relationships between entity instances of the plurality of different entities is accessed. Multiple entity instance relationship sets may identify the same relationship between entity instances of the different entities. From the plurality of entity instance relationship sets, a subset of entity instance relationship sets that identify a relationship between entity instances of the selected entity types is selected. Moreover, for each different identified relationship between the entity instances of the selected entity types, only a single entity instance relationship set is selected for the subset, such that the subset does not contain multiple entity instance relationship sets that identify the same relationship between entity instances of the selected entity types.

For each entity instance relationship set in the subset, attribute data from each of the entity instances identified as having a relationship in the entity instance relationship set is presented in the user interface. Accordingly, simply by selecting any combination of entity types, the user is presented with a list of the relationships between entity instances of the selected combination of entity types. The user may then select a different combination of entity types, and in response be presented with a list of the relationships between entity instances of the newly selected combination of entity types.

In one embodiment, each entity instance relationship set includes entity instance identifiers, each of which uniquely identifies an entity instance of a particular entity type. The entity instance relationship set may also include additional attribute data regarding the entity instances identified in the entity instance relationship set, which may be presented to the user.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a block diagram of an exemplary system in which embodiments disclosed herein may be practiced;

FIG. 2 is a block diagram illustrating aspects of an exemplary database;

FIG. 3 is a flowchart of a method for presenting information that identifies relationships between entity instances of different entity types modeled in a database, according to one embodiment;

FIG. 4 illustrates a plurality of exemplary entity instance relationship sets in the context of the database illustrated in FIG. 2, according to one embodiment;

FIG. 5 illustrates an exemplary table containing data that may be used by a relationship presentation function in conjunction with presenting information identifying relationships between entity instances of different entity types to a user;

FIG. 6 is a flowchart illustrating another exemplary method for presenting information identifying relationships between entity instances of different entity types;

FIG. 7 illustrates an exemplary user interface that may be presented by the relationship presentation function according to one embodiment;

FIG. 8 illustrates a table that contains rows, each of which identifies a unique relationship between a customer entity instance and a product entity instance;

FIGS. 9A-9B illustrate a user interface according to embodiments disclosed herein;

FIGS. 10A-10B illustrate a user interface according to additional embodiments disclosed herein;

FIG. 11 is a block diagram illustrating an exemplary process for generating a subset of entity instance relationship sets that contain only a single entity instance relationship set for each different relationship between entity instances of selected entity types;

FIG. 12 is a block diagram of another exemplary plurality of entity instance relationship sets; and

FIG. 13 illustrates an exemplary computing device according to one embodiment.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Embodiments disclosed herein relate to presenting information identifying relationships between different types of things modeled, or represented, in a database. For purposes of illustration, embodiments will be illustrated in the context of a relational database, but the embodiments are not limited to any particular form of database. As used herein, the term “database” refers to any data structure suitable for retaining information, such as a file, a spreadsheet, a database management system, or the like.

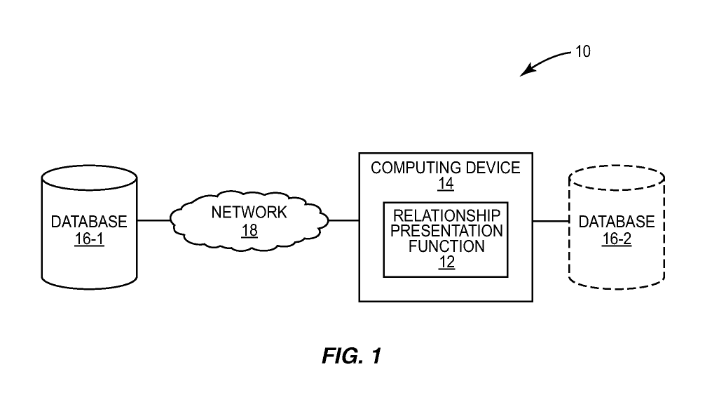

FIG. 1 is a block diagram of an exemplary system 10 in which embodiments disclosed herein may be practiced. The system 10 includes a relationship presentation function 12 that executes on a computing device 14, such as a computer. In one embodiment, the relationship presentation function 12 accesses information associated with a database 16-1 that is coupled to a network 18. Alternately, the relationship presentation function 12 may access information associated with a locally connected database 16-2, as illustrated in dashed outline in FIG. 1.

Generally, as discussed in greater detail with reference to the subsequent Figures, the relationship presentation function 12 accesses information that identifies relationships between particular entity instances of the database 16-1, and based on this information, and in response to user input, presents information that identifies relationships between entity instances of different entity types. The relationship presentation function 12 can present such information based on any combination of selected entity types, and need not be modified, altered, tested, debugged, or re-compiled to do so. Rather, in conjunction with the information that identifies relationships between particular entity instances, the relationship presentation function 12 provides a highly intuitive and flexible mechanism that enables a user to rapidly ascertain how information stored in the database 16-1 is related. Knowledge of such relationships may be used in any of a number of different applications, such as for advertising, marketing, or any other endeavor in which such knowledge would be useful.

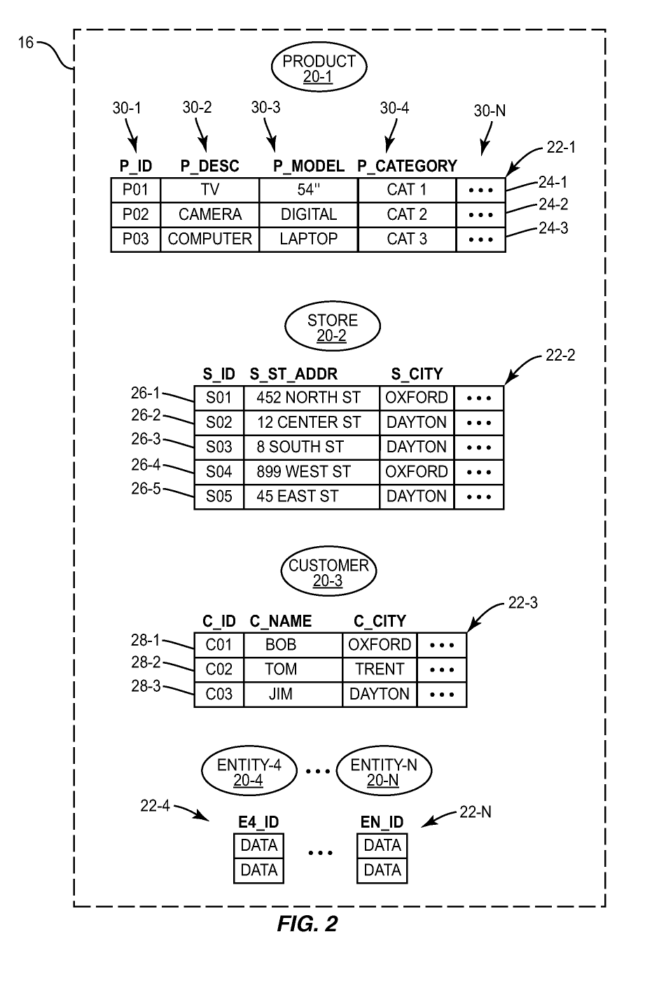

Prior to delving into the details of the operation of the relationship presentation function 12, background and terminology relating to databases will be discussed to provide context for the subsequent discussion. FIG. 2 is a block diagram illustrating aspects of an exemplary database 16. The database 16 models, or represents, a plurality of entities 20-1-20-N (generally, entities 20). Each entity 20 is of a particular entity type. In database terminology, an entity is an abstraction that represents a discrete thing (although not necessarily a physical thing) in a particular context. For example, in the database 16, the entities 20-1-20-3 represent, respectively, products, stores, and customers in a product retailer context. Entities 20-4-20-N may represent any other distinct things that may be useful in the product retailer context, and are illustrated to emphasize that while for purposes of illustration, the embodiments will be disclosed in the context of relationships among the three entities 20-1-20-3, the embodiments are not limited to any particular number of entities 20, and may be used to analyze the relationships among any number of different types of entities 20. The use of ellipses throughout the Figures indicates the presence of zero or more additional elements that may be present, but for purposes of clarity and brevity, are not illustrated.

Abstract entities 20-1-20-N are implemented in tangible form in the database 16 via corresponding entity structures 22-1-22-N (generally, entity structures 22). An entity structure 22 may be implemented in any desired format, however, for purposes of illustration, the entity structures 22 will be described as having a tabular format with one or more rows of information and one or more columns of information. Each row in an entity structure 22 represents an entity instance of that particular entity 20. Each entity instance corresponds to a particular one, or instance, of the thing being modeled by that particular entity 20, and is of the entity type of that particular entity 20.

For example, the entity structure 22-1 contains three entity instances 24-1-24-3 (generally, entity instances 24), each of which corresponds to a particular (different) product, and thus, each of which is a product-type entity instance 24. The entity structure 22-2 contains five entity instances 26-1-26-5 (generally, entity instances 26), each of which corresponds to a particular (different) store, and thus, each of which is a store-type entity instance 26. The entity structure 22-3 contains three entity instances 28-1-28-3 (generally, entity instances 28), each of which corresponds to a particular (different) customer, and thus, each of which is a customer-type entity instance 28. While each entity structure 22 is shown, for purposes of illustration, as having a relatively small number of entity instances, it should be apparent that in practice, one or more of the entity structures 22 may have thousands, or hundreds of thousands, of entity instances. For example, a large retailer may have hundreds of thousands of different customers, and thus the entity structure 22-3 may have a corresponding number of entity instances 28.

Entity instances comprise data that describe the thing being modeled, or represented. Such data are categorized into different entity attributes, with each entity attribute being associated with different data. With respect to an entity structure 22, entity attribute data about an entity are typically illustrated in a columnar fashion. Each entity attribute typically has an attribute name, or label. The entity attribute names are preferably indicative of the information, or data, stored in the entity attribute of a particular instance of the entity. Referring to the entity structure 22-1, for example, entity attribute names include “P_ID,” which is the name of an entity attribute whose attribute data contain a unique identifier that uniquely identifies the product that corresponds to the particular entity instance 24; “P_DESC,” which is the name of an entity attribute whose attribute data contain the description of the product corresponding to the particular entity instance 24; “P_MODEL,” which is the name of an entity attribute whose attribute data contain the model of the product corresponding to the particular entity instance 24; and “P_CATEGORY,” which is the name of the entity attribute whose attribute data contain the product category of the product corresponding to the particular entity instance 24.

The attribute data associated with the respective entity attribute are illustrated in corresponding columns 30-1-30-N of the entity structure 22-1. Thus, the attribute data associated with the entity attribute P_ID of entity instance 24-1 is “P01,” the attribute data associated with the entity attribute P_DESC is “TV,” the attribute data associated with the entity attribute P_MODEL is 54″, and the attribute data associated with the entity attribute P_CATEGORY is “CAT 1.”

In a similar fashion, the entity structures 22-2-22-N include one or more entity instances, each of which contains entity attribute data associated with that particular entity type. Each of the entity instances of the entity structures 22-1-22-4 includes, among other entity attributes, an entity attribute that uniquely identifies that entity instance from any other entity instance of that particular entity type. As mentioned previously, the unique entity attribute for the product entity type is the P_ID attribute. Thus, the P_ID attribute data of each entity instance 24 is unique. Similarly, the store entity 20-2 includes an “S_ID” attribute whose data uniquely identify store entity instances, and the customer entity 20-3 includes a “C_ID” attribute whose data uniquely identify customer entity instances. Such unique entity attributes will be referred to herein as entity instance identifiers.

For purposes of illustration and clarity, a reference to an entity instance or an entity structure 22 may be preceded by the particular entity type of the entity instance or entity structure 22 hereinafter. For example, the entity structure 22-1 may be referred to as the product entity structure 22-1, and an entity instance stored in the product entity structure 22-1 may be referred to as a product entity instance 24.

For purposes of illustration and clarity, references may be made herein from time to time to entity instances of an entity 20. Any such reference means that the entity instance is of the type of entity 20, and the actual attribute data that define the entity instance are maintained in a corresponding entity structure 22. For example, a reference to an entity instance of the product entity 20-1 means that the entity instance corresponds to a particular product, and the attribute data that define the particular entity instance are stored in the entity structure 22-1.

Entity instances of one entity structure 22 may have relationships with entity instances of another entity structure 22. Some relationships among entity instances may be relatively obvious, and others, less so. For example, a customer entity instance 28 of the customer entity structure 22-3 has a relationship with a particular product entity instance 24 of the product entity structure 22-1 if the customer corresponding to the customer entity instance 28 purchased the product corresponding to the particular product entity instance 24. This information may be valuable to the retailer because it may provide the retailer with potentially useful information about the customer, such as the fact that the customer may be a country music fan if the product is a country music CD. The particular product entity instance 24 is also related to a particular store entity instance 26 of the store entity structure 22-2 by virtue of the fact that the product was sold by the particular store that corresponds to that store entity instance 26. Notably, this latter relationship actually suggests a relationship between the particular customer entity instance 28 and the particular store entity instance 26 in that the particular customer purchased the country music CD from the particular store.

Understanding the relationships among entity instances can be valuable. For example, a retailer may be able to send specific and highly relevant offers to a particular customer if the retailer knows that the customer shops at a particular retailer location, or purchases particular categories of products. Consequently, it is not unusual for a database owner to want to know what relationships exist among the entity instances in a database.

Determining relationships among entity instances may be relatively simple where a database models only a few types of entities. However, in practice, databases may model hundreds of different types of entities. Determining all the relationships among entity instances of hundreds of different entity structures 22 may be quite time-consuming, and once determined, writing the software reporting application(s) necessary to extract the data from the entity structures 22 in accordance with the determined relationships is also time-consuming and may be expensive.

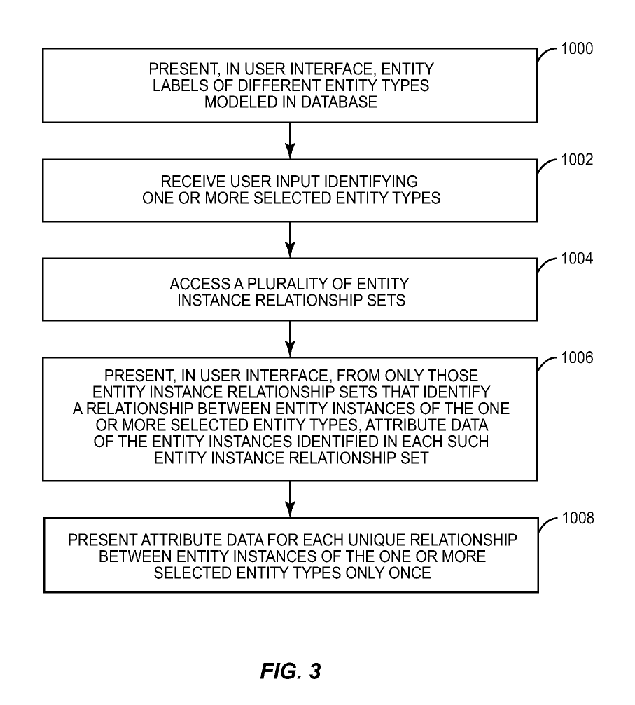

FIG. 3 is a flowchart of a method for presenting information that identifies relationships between entity instances of different entity types modeled in a database, according to one embodiment. The user is initially presented, in a user interface on a display, with data that identify different entity types that are modeled, or represented, in a database (step 1000). Any number of different entity types may be presented to the user. Large databases may include hundreds of different entity types, and thus the user may be presented with data identifying hundreds of different entity types. The user interface may facilitate the display of a large number of entity types through a scrolling mechanism or any other user interface feature suitable for presenting a large quantity of data to a user. The entity types may be identified via an entity label, or entity name, such as “Products,” “Customers,” “Stores,” or the like. In proximity to each such entity label the user interface preferably provides a user interface control (UI control) that permits the user to select the entity, such as a check box.

User input identifying one or more selected entity types is received (step 1002). For example, if the user wishes to view the relationships between customers and products, the user would identify, via a check box or other UI control, the “Product” entity label and the “Customer” entity label. In response, a plurality of entity instance relationship sets is accessed (step 1004). Details regarding entity instance relationship sets will be discussed below, but generally, each entity instance relationship set identifies a relationship between entity instances of different entity types.

Attribute data of entity instances identified in only those entity instance relationship sets that identify a relationship between entity instances of the selected entity types is displayed in the user interface (step 1006). Preferably, attribute data for each unique relationship between entity instances of the selected entity types is presented only once, such that the same relationship is not presented twice in the user interface (step 1008). The attribute data is presented in the user interface such that the attribute data from each such entity instance relationship set is presented in association with one another, such as in a row of a table, or via any other illustrative mechanism, such that it is clear that the attribute data is related.

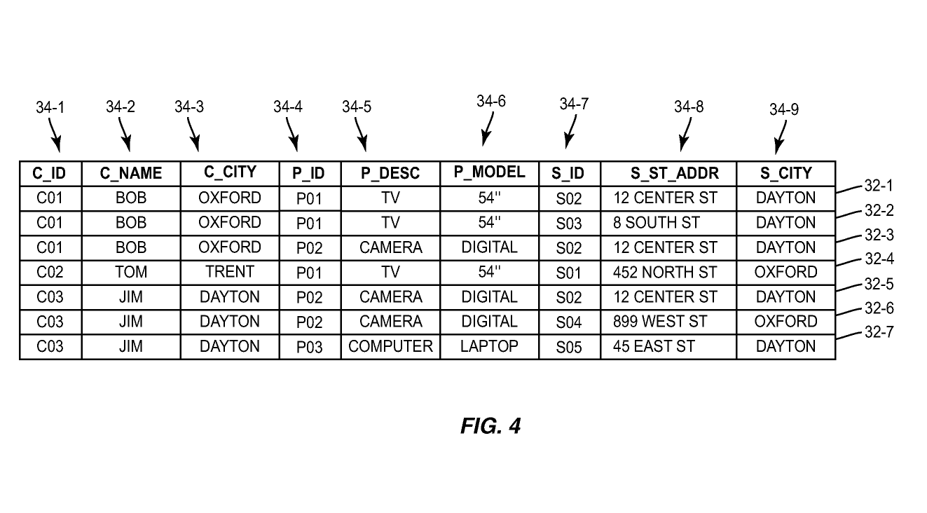

FIG. 4 illustrates a plurality of exemplary entity instance relationship sets 32-1-32-7 (generally, entity instance relationship sets 32), in the context of the database 16 illustrated in FIG. 2, according to one embodiment. For purposes of illustration, the entity instance relationship sets 32 are illustrated as rows in a table, and indeed, in one embodiment, they may comprise a database structure such as a table in a database, but the embodiments are not limited to any particular structure of entity instance relationship sets 32. In other embodiments, the entity instance relationship sets 32 may comprise linked lists, or may comprise any other data structure capable of storing information in association with one another.

Each entity instance relationship set 32 comprises attribute data relating to entity instances stored in the database 16 (FIG. 2), and at a minimum comprises unique entity attributes that identify entity instances of different entity types that are related to one another. For purposes of illustration, the attribute data associated with each of the entity instance relationship sets 32 is shown in columns 34-1-34-9, and an attribute name, or label, is illustrated at the top of each column. Thus, for each entity instance relationship set 32, the entity attribute data in column 34-1 (labeled “C_ID”) contains the unique entity attribute data that uniquely identifies a particular customer entity instance 28 in the customer entity structure 22-3 (FIG. 2) which models, or represents, a particular customer. The entity attribute data in column 34-2 (labeled “C_NAME”) contains name entity attribute data that identifies the name of the customer represented by the entity instance identified by the unique entity attribute data contained in the column 34-1. The entity attribute data in column 34-3 (labeled “C_CITY”) contains city entity attribute data that identifies the city where the customer represented by the entity instance identified by the unique entity attribute data contained in the column 34-1.

The entity attribute data in column 34-4 (labeled “P_ID”) contains the unique entity attribute data that uniquely identifies a particular product entity instance 24 in the product entity structure 22-1. The entity attribute data in column 34-5 (labeled “P_DESC”) contains description entity attribute data that identifies a description of the product represented by the entity instance identified by the unique entity attribute data contained in the column 34-4. The entity attribute data in column 34-6 (labeled “P_MODEL”) contains model attribute data that identifies the model of the product represented by the entity instance identified by the unique entity attribute data contained in the column 34-4. The entity attribute data in column 34-7 (labeled “S_ID”) contains the unique entity attribute data that uniquely identifies a particular store entity instance 26 in the store entity structure 22-2. The entity attribute data in column 34-8 (labeled “S_ST_ADDR”) contains street address entity attribute data that identifies a street address of the store represented by the entity instance identified by the unique entity attribute data contained in the column 34-7. The entity attribute data in column 34-9 (labeled “S_CITY”) contains city attribute data that identifies the city of the store represented by the entity instance identified by the unique entity attribute data contained in the column 34-7.

The entity instances identified in an entity instance relationship set 32 are related to one another. For example, the entity instance relationship set 32-1 indicates that the customer entity instance 28 identified by the unique entity attribute data “C01” (i.e., customer entity instance 28-1, FIG. 2), is related to the product identified by the unique entity attribute data “P01” (i.e., product entity instance 24-1, FIG. 2), and is further related to the store identified by the unique entity attribute data “S02” (i.e., store entity instance 26-2, FIG. 2). The relationships between entity instances of different entity types identified in the entity instance relationship sets 32 may be determined in any desirable manner, such as, for example, by recording such relationships as they occur. For example, with respect to the entity instance relationship set 32-1, such information may be recorded on the date the customer Bob purchases a TV at the store on 12 Center Street in Dayton. In particular, the retailer's database software may, upon checkout, generate the entity instance relationship set 32-1.

Alternatively, the entity instance relationship set 32 may be generated from other data stored in the database 16 that identifies relationships between entity structures 22, such as the method disclosed in U.S. patent application Ser. No. 13/113,579, which is hereby incorporated herein in its entirety. Note that although each entity instance relationship set 32 illustrated in FIG. 4 identifies a unique (i.e., different) relationship between three entity instances of different entity types only once, such entity instance relationship sets 32 may necessarily identify the same relationship between a subset of the entity instances multiple times. For example, the entity instance relationship set 32-1 identifies a relationship between the customer “C01” and the product “P01,” and the entity instance relationship set 32-2 also identifies the same relationship between the customer “C01” and the product “P01.” In this example, this is because the customer “C01” purchased the same product “P01” at two different stores, store “S01” and store “S02.” As will be discussed in detail below, if the user is interested in ascertaining the relationships between customer entity instances and product entity instances, it may not be desirable to identify the same relationship multiple times.

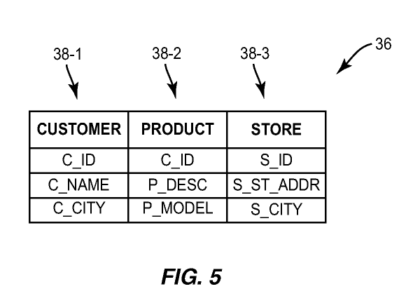

FIG. 5 illustrates an exemplary table 36 containing data that may be used by the relationship presentation function 12 (FIG. 1) in conjunction with presenting information identifying relationships between entity instances of different entity types to the user. Such table 36 may be generated by the user prior to execution of the relationship presentation function 12, may be hard-coded into the relationship presentation function 12, or some or all of the information depicted therein may be solicited from the user by the relationship presentation function 12 during execution. Generally, the information in the table 36 identifies to the relationship presentation function 12 information that includes entity labels of one or more different entities, unique entity attributes that correspond to the one or more different entities, and additional entity attributes of the one or more different entities which will be presented to the user. In this example, a column 38-1 identifies the “CUSTOMER” entity; the unique entity attribute “C_ID” that uniquely identifies customer entity instances 28; and other entity attributes “C_NAME” and “C_CITY,” which are associated with customer entity instances. A column 38-2 identifies the “PRODUCT” entity; the unique entity attribute “P_ID” that uniquely identifies product entity instances 24; and other entity attributes “P_DESC” and “P_MODEL,” which are associated with product entity instances. A column 38-3 identifies the “STORE” entity; the unique entity attribute “S_ID” that uniquely identifies store entity instances; and other entity attributes “S_ST_ADDR” and “S_CITY,” which are associated with store entity instances.

The information in the table 36 may be used by the relationship presentation function 12 for several purposes. In particular, the relationship presentation function 12 may use the identification of the different entities as the entity label, or entity name, which is presented to the user in the user interface. The relationship presentation function 12 may also use the information to identify the unique entity attribute that is used in the entity instance relationship sets 32 to identify relationships between entity instances of different entity types. The relationship presentation function 12 may also use the information to identify additional entity attribute data from each identified entity instance which will be presented to the user.

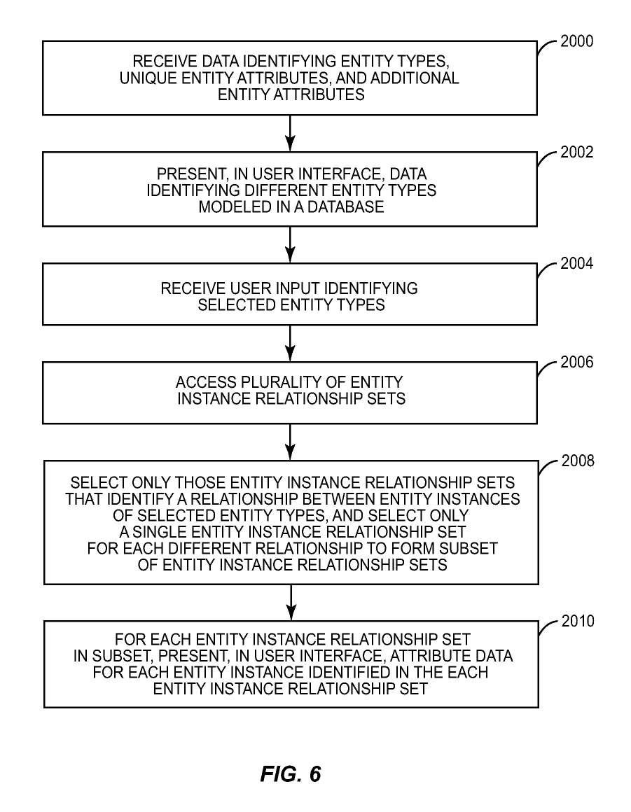

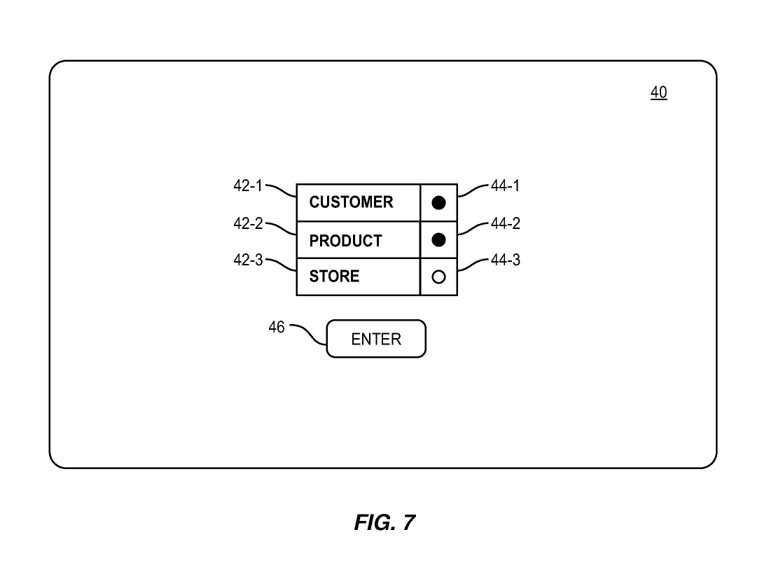

FIG. 6 is a flowchart illustrating another exemplary method for presenting information identifying relationships between entity instances of different entity types. Initially, the relationship presentation function 12 receives data identifying entity types, unique entity attributes, and additional entity attributes (step 2000). As discussed above, such information may be stored in a data structure, such as the table 36 (FIG. 5). The relationship presentation function 12 then presents, in a user interface, data identifying the different entity types identified in the table 36. FIG. 7 illustrates an exemplary user interface 40 that may be presented by the relationship presentation function 12 according to one embodiment. FIG. 7 will be discussed in conjunction with FIG. 6. The user interface 40 presents to the user entity labels 42-1-42-3, which identify entity types in the database 16 (FIG. 2), and which were determined by the relationship presentation function 12 via the table 36 (FIG. 5) or some other mechanism. The user interface 40 includes selectable controls 44-1-44-3 via which the user may provide input identifying one or more selected entity types of the plurality of entity types depicted in the user interface 40. Assume that the user selects the controls 44-1 and 44-2 to indicate a desire to see all relationships between customer entity instances 28 and product entity instances 24. In other words, the user may want to determine what customers have purchased which products. The user may indicate the completion of the selection via a UI control such as an enter control 46.

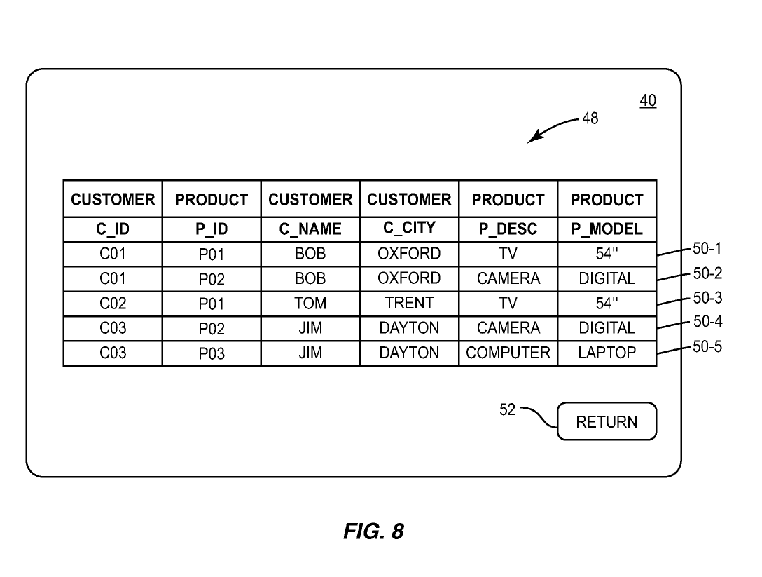

The relationship presentation function 12 receives the user input identifying the selected entity types (FIG. 6, step 2004). In one embodiment, the relationship presentation function 12 accesses the entity instance relationship sets 32 and selects only those entity instance relationship sets 32 that identify a relationship between entity instances of the selected entity types (in this example, those entity instance relationship sets 32 that identify a relationship between customer entity instances and product entity instances), and further selects only a single entity instance relationship set 32 for each different relationship between customer entity instances 28 and product entity instances 24 to form a subset of entity instance relationship sets 32 (step 2008). Thus, the subset of entity instance relationship sets 32 does not identify the same relationship between the same customer entity instance 28 and product entity instance 24 multiple times. For each entity instance relationship set 32 in the subset, the relationship presentation function 12 presents in the user interface 40 attribute data for each entity instance identified in the entity instance relationship set 32 (step 2010). Such attribute data may be presented in a format illustrated in FIG. 8. FIG. 8 includes a table 48 that contains rows 50-1-50-5, each of which identifies a unique relationship between a customer entity instance 28 and a product entity instance 24. In particular, row 50-1 indicates a relationship between the customer C01 and the product P01, row 50-2 indicates a relationship between the customer C01 and product P02, row 50-3 indicates a relationship between customer C02 and the product P01, row 50-4 indicates a relationship between customer C03 and the product P02, and row 50-5 indicates a relationship between the customer C03 and product P03. Notably, certain of these relationships were identified multiple times in the entity instance relationship sets 32 (FIG. 4), such as the relationship between the customer C01 and product P01, but such relationship is identified only once in the table 48.

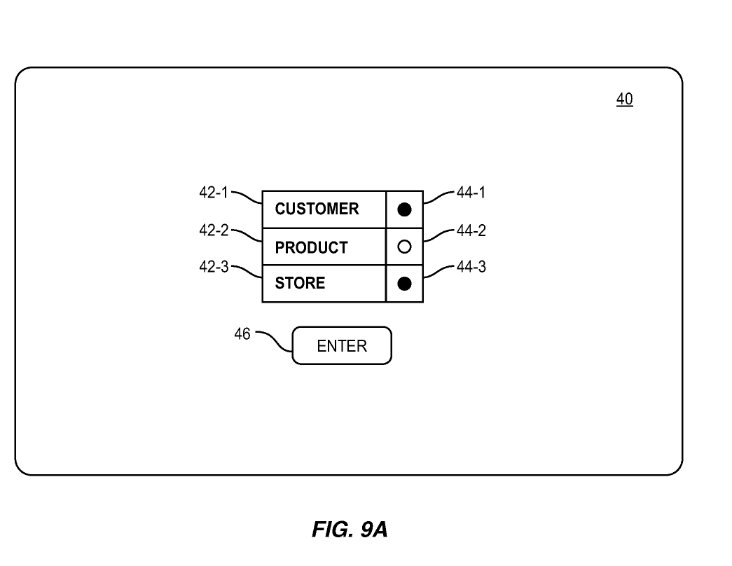

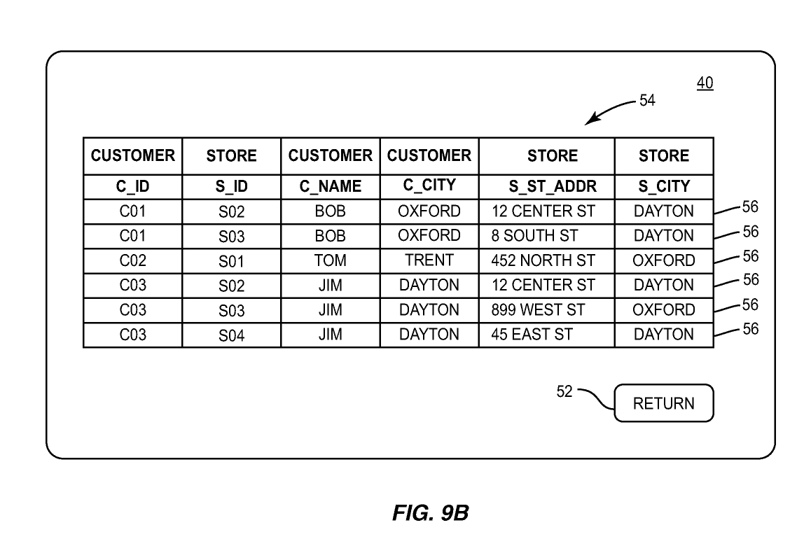

The user may iteratively request that the relationship presentation function 12 present information showing relationships between entity instances of different entity types. For example, the user may select a return user control 52, which causes the relationship presentation function 12 to again present to the user the user entity labels 42-1-42-3, as illustrated in FIG. 9A.

Assume that the user selects the selectable controls 44-1 and 44-3, and then selects the enter control 46 to indicate that the user would like to see the relationships between the customer entity instances 28 and the store entity instances 26. In response, the relationship presentation function 12 accesses the entity instance relationship sets 32 and selects only those entity instance relationship sets 32 that identify a relationship between customer entity instances 28 and store entity instances 26, and further selects only a single entity instance relationship set 32 for each different relationship between a customer entity instance 28 and a store entity instance 26 to form a subset of entity instance relationship sets 32. For each entity instance relationship set 32 in the subset, the relationship presentation function 12 presents in the user interface 40 attribute data for each entity instance identified in the entity instance relationship set 32, as illustrated in FIG. 9B.

FIG. 9B illustrates a table 54 that contains a plurality of rows 56. Each row 56 identifies a different relationship between a particular customer entity instance 28 and a particular store entity instance 26.

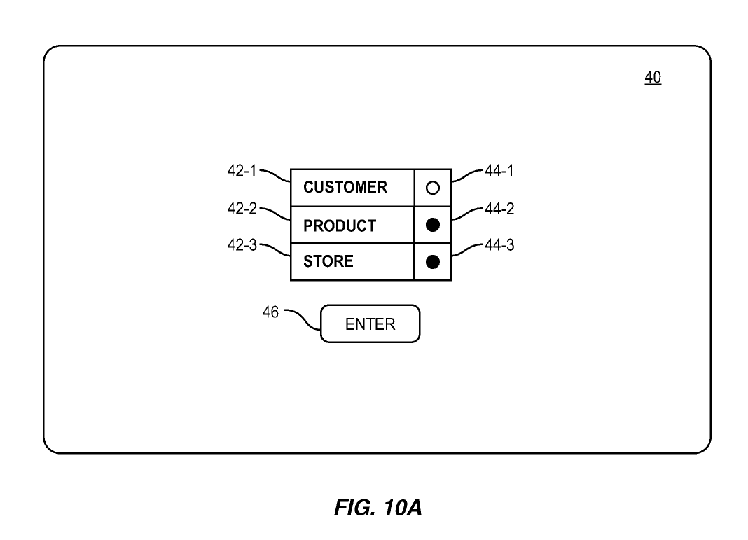

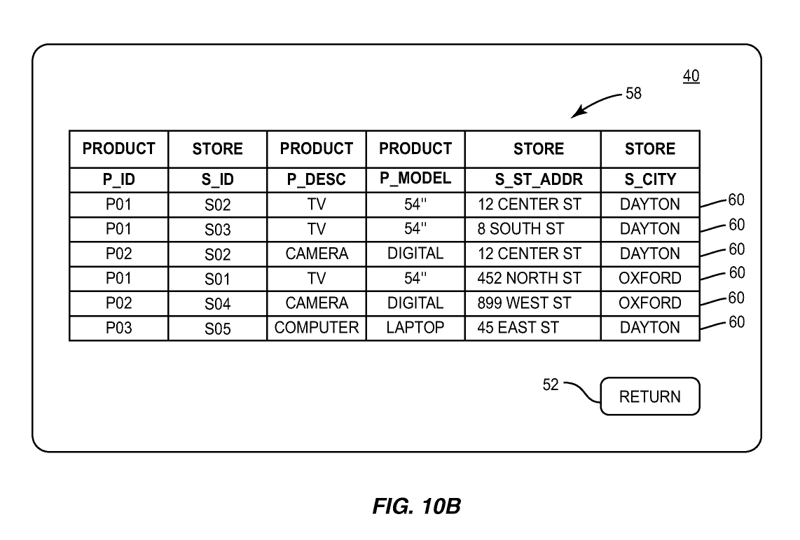

Assume that the user selects the return user control 52, which causes the relationship presentation function 12 to again present to the user the entity labels 42-1-42-3, as illustrated in FIG. 10A. Assume that the user selects the selectable controls 44-2 and 44-3, and then selects the enter control 46 to indicate that the user would like to see the relationships between the product entity instances 24 and the store entity instances 26. In response, the relationship presentation function 12 accesses the entity instance relationship sets 32 and selects only those entity instance relationship sets 32 that identify a relationship between product entity instances 24 and store entity instances 26, and further selects only a single entity instance relationship set 32 for each different relationship between a product entity instance 24 and a store entity instance 26 to form a subset of entity instance relationship sets 32. For each entity instance relationship set 32 in the subset, the relationship presentation function 12 presents in the user interface 40 attribute data for each entity instance identified in the entity instance relationship set 32, as illustrated in FIG. 10B. FIG. 10B illustrates a table 58 that contains a plurality of rows 60. Each row 60 identifies a different relationship between a particular product entity instance 24 and a particular store entity instance 26.

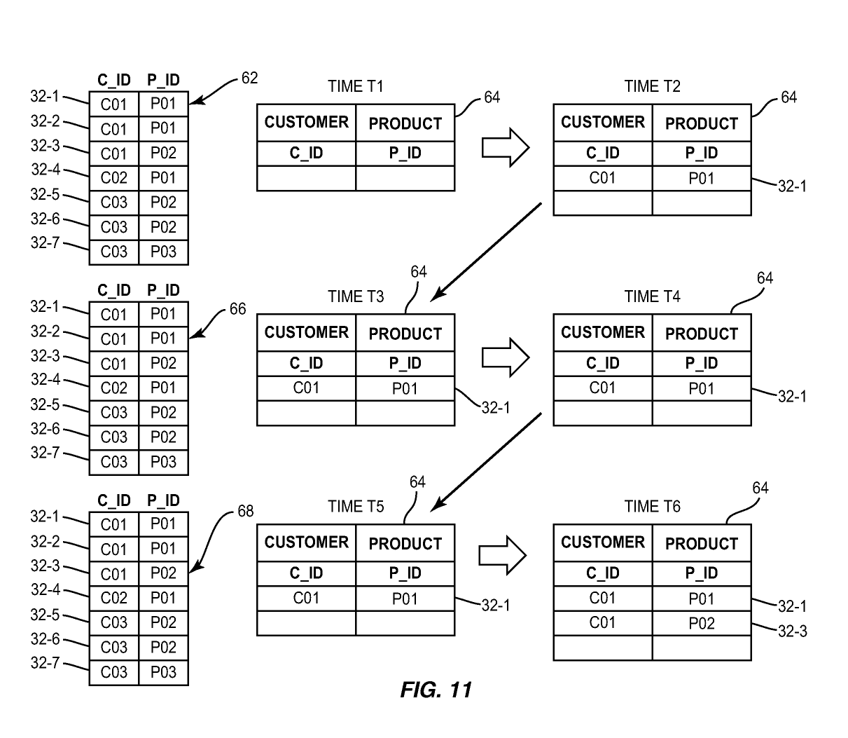

FIG. 11 is a block diagram illustrating an exemplary process for generating a subset of entity instance relationship sets 32 that contain only a single entity instance relationship set 32 for each different relationship between entity instances of selected entity types. Assume for purposes of illustration that the user has selected, via the user interface 40, selectable controls 44-1 and 44-2, thereby indicating a desire to be presented with information identifying relationships between customer entity instances 28 and product entity instances 24. The relationship presentation function 12 accesses the first of the plurality of entity instance relationship sets 32, in particular the entity instance relationship set 32-1, as indicated by arrow 62. For purposes of illustration, only the columns of the entity instance relationship sets 32 containing the unique entity attributes C_ID and P_ID are depicted in FIG. 11, although it will be understood that each entity instance relationship set 32 may comprise additional attribute data as illustrated in FIG. 4.

The relationship presentation function 12 then begins assembling a subset 64 of entity instance relationship sets 32, such that each entity instance relationship set 32 in the subset 64 identifies a relationship between a customer entity instance 28 and a product entity instance 24. Initially, at a time T1, the subset 64 comprises an empty subset. The relationship presentation function 12 accesses the subset 64 and determines that the relationship between the customer C01 and the product P01 is not reflected in the subset 64, and then inserts the entity instance relationship set 32-1 into the subset 64, as reflected by the subset 64 at time T2. The relationship presentation function 12 then accesses the next entity instance relationship set 32, in particular entity instance relationship set 32-2, as indicated by arrow 66. The relationship presentation function 12 accesses the subset 64 at time T3 and determinates that the subset 64 already contains the entity instance relationship set 32-1, which identifies the same relationship between the customer C01 and the product P01 that is identified by the entity instance relationship set 32-1. Thus, the relationship presentation function 12 does not insert the entity instance relationship set 32-2 into the subset 64, as indicated at time T4, so that the subset 64 does not identify the same relationship multiple times.

The relationship presentation function 12 then accesses the entity instance relationship set 32-3, as indicated by the arrow 68, and at time T5 determines that the subset 64 does not contain an entity instance relationship set 32 that identifies the relationship that is identified in the entity instance relationship set 32-3. The relationship presentation function 12 therefore inserts the entity instance relationship set 32-3 into the subset 64, as indicated at time T6. This process continues until the relationship presentation function 12 has processed each entity instance relationship set 32. After the final entity instance relationship set 32 has been processed, the subset 64 contains only one entity instance relationship set 32 for each unique, or different, relationship between a customer entity instance 28 and a product entity instance 24.

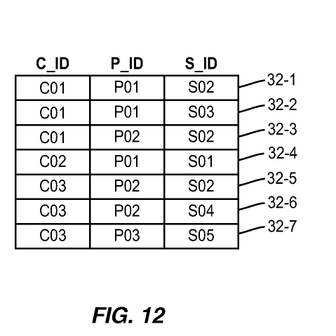

FIG. 12 is a block diagram of another exemplary plurality of entity instance relationship sets 32. In this example, each entity instance relationship set 32 identifies the same relationships between the customer entity instances 28, the product entity instances 24, and the store entity instances 26 that are identified by the entity instance relationship sets 32 in FIG. 4. However, the entity instance relationship sets 32 in FIG. 12 identify only the unique attributes C_ID, P_ID, and S_ID, and do not contain the other entity attributes such as the P_DESC attribute, the S_CITY attribute, and the like, as illustrated in FIG. 4.

In this embodiment, the relationship presentation function 12 uses the unique entity attribute data from each entity instance relationship set 32 to access the particular entity instance from the corresponding entity structure 22, and extracts the desired additional entity attributes from such entity instance. For example, the relationship presentation function 12 may access the entity instance relationship set 32-1 to identify the unique customer entity attribute data “C01,” and may then use this attribute data to access the entity instance 28-1 from the entity structure 22-3 (FIG. 2). The relationship presentation function 12 may than access the C_NAME attribute data (e.g., “Bob”) from the entity instance 28-1 and the C_CITY attribute data (e.g., “Oxford”) from the entity instance 28-1, and may provide such information in the user interface 40.

As illustrated, among other features, the embodiments herein enable a user to easily and intuitively determine the relationships between entity instances of different entity structures 22 in databases without the need to develop new software for each different combination of relationships that is desired.

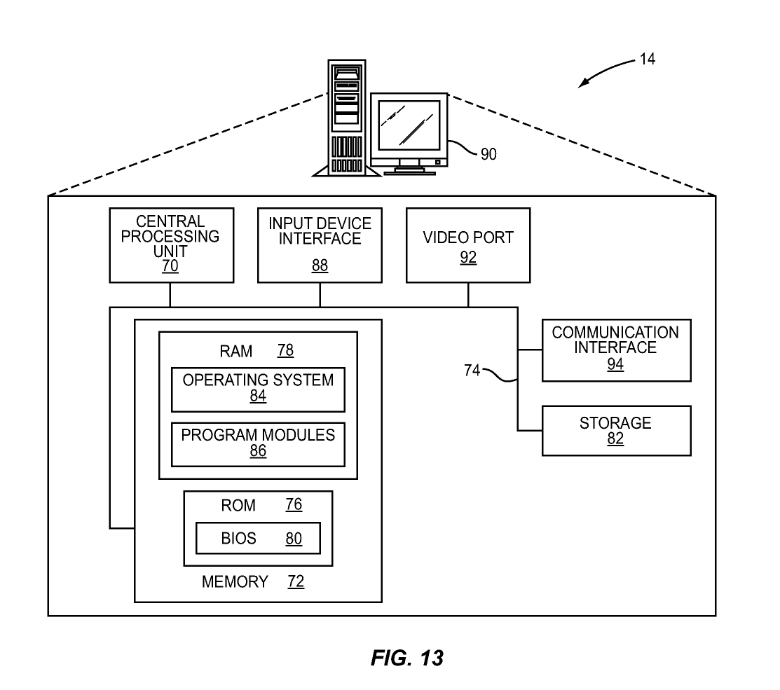

FIG. 13 illustrates the exemplary computing device 14 (FIG. 1) according to one embodiment. The computing device 14 may comprise, for example, a laptop computer, a desktop computer, a workstation, a proprietary mainframe computer, or the like. Alternately, the computing device 14 may comprise a special purpose computing device wherein the special purpose is to provide the functionality described herein. In addition to components discussed previously herein, the exemplary computing device 14 may include a processor, such as a central processing unit 70; a system memory 72; and a system bus 74. The system bus 74 provides an interface for system components including, but not limited to, the system memory 72 and the central processing unit 70. The central processing unit 70 can be any of various commercially available or proprietary processors. Dual microprocessors and other multi-processor architectures may also be employed as the central processing unit 70.

The system bus 74 may be any of several types of bus structures that may further interconnect to a memory bus (with or without a memory controller), a peripheral bus, and/or a local bus using any of a variety of commercially available bus architectures. The system memory 72 may include non-volatile memory 76 (e.g., read only memory (ROM), erasable programmable read only memory (EPROM), electrically erasable programmable read only memory (EEPROM), etc.) and/or volatile memory 78 (e.g., random access memory (RAM)). A basic input/output system (BIOS) 80 may be stored in the non-volatile memory 76, and can include the basic routines that help to transfer information between elements within the computing device 14. The volatile memory 78 may also include a high-speed RAM such as static RAM for caching data.

The computing device 14 may further include a computer-readable storage 82, which may comprise, for example, an internal hard disk drive (HDD) (e.g., enhanced integrated drive electronics (EIDE) or serial advanced technology attachment (SATA)) for storage, flash memory, or the like. The database 16 (FIG. 2) may be stored in the computer-readable storage 82, for example. The drives and associated computer-readable and computer-usable media provide non-volatile storage of data, data structures, computer-executable instructions, and so forth. Although the description of computer-readable media above refers to an HDD, it should be appreciated by those skilled in the art that other types of media which are readable by a computer, such as Zip disks, magnetic cassettes, flash memory cards, cartridges, and the like, may also be used in the exemplary operating environment, and further, that any such media may contain computer-executable instructions for performing novel methods of the disclosed architecture.

A number of program modules can be stored in the computer-readable storage 82 and in the volatile memory 78, including an operating system 84 and one or more program modules 86, which may implement the functionality described herein in whole or in part, including, for example, functionality described with respect to the relationship presentation function 12 (FIG. 1), and other processing and functionality described herein. It is to be appreciated that the embodiments can be implemented with various commercially available operating systems 84 or combinations of operating systems 84.

All or a portion of the embodiments may be implemented as a computer program product stored on a non-transitory computer-usable or computer-readable medium, such as the storage 82, and including instructions configured to cause the central processing unit 70 to carry out the steps described herein. Thus, the computer-readable program code can comprise software instructions for implementing the functionality of the embodiments described herein when executed on the central processing unit 70. The central processing unit 70, in conjunction with the program modules 86 in the volatile memory 78, may serve as a control system for the computing device 14 that is configured to, or adapted to, implement the functionality described herein.

Alternately, all or a portion of the relationship presentation function 12 may be implemented in hardware, such as in a special-purpose database processor designed specifically to implement the functionality discussed herein.

An administrator may be able to enter commands and information into the computing device 14 through one or more input devices, such as, for example, a touch sensitive display (not illustrated); a keyboard (not illustrated); or a pointing device, such as a mouse (not illustrated). Other input devices (not illustrated) may include a microphone, an infrared (IR) remote control, a joystick, a game pad, a stylus pen, or the like. These and other input devices may be connected to the central processing unit 70 through an input device interface 88 that is coupled to the system bus 74, but can be connected by other interfaces such as a parallel port, an IEEE 13114 serial port, a game port, a universal serial bus (USB) port, an IR interface, etc.

The computing device 14 may drive a separate or integral display 90, which may also be connected to the system bus 74 via an interface, such as a video port 92. The computing device 14 preferably includes a communication interface 94 for communicating with the network 18 (FIG. 1), which may comprise, for example a wireless LAN or wireless personal area network technology, including, for example, Wi-Fi®, Bluetooth®, or ZigBee®.

Those skilled in the art will recognize improvements and modifications to the preferred embodiments of the present disclosure. All such improvements and modifications are considered within the scope of the concepts disclosed herein and the claims that follow.

What is claimed is:

1. A method for presenting data, comprising:
presenting, by a computing device, in a user interface, entity labels identifying a plurality of different entity types modeled in a database;
receiving, by the computing device, input identifying one or more selected entity types of the plurality of different entity types;
accessing, by the computing device, a plurality of entity instance relationship sets, each entity instance relationship set identifying a relationship between entity instances of at least two different entity types of the plurality of different entity types;
selecting, from the plurality of entity instance relationship sets, only those entity instance relationship sets that identify a relationship between entity instances of the one or more selected entity types to form a subset of entity instance relationship sets, wherein only a single entity instance relationship set is selected for each different identified relationship; and
for each entity instance relationship set in the subset, presenting, in the user interface, attribute data from each of the entity instances identified as having a relationship in the each entity instance relationship set.

2. The method of claim 1, wherein each entity instance relationship set comprises a row in a database structure.

3. The method of claim 1, wherein each entity instance relationship set identifies a relationship between entity instances of at least three different entity types of the plurality of different entity types.

4. The method of claim 1, wherein each entity instance relationship set comprises entity instance identifiers, each of which uniquely identifies one of the entity instances of the at least two different entity types.

5. The method of claim 1, wherein the plurality of entity instance relationship sets comprises multiple entity instance relationship sets that identify a same relationship between the entity instances of the at least two different entity types of the plurality of different entity types.

6. The method of claim 1, wherein the attribute data from each of the entity instances identified as having the relationship in the each entity instance relationship set is stored in the each entity instance relationship set.

7. The method of claim 1, further comprising:
prior to presenting, in the user interface, the entity labels identifying the plurality of different entity types modeled in the database, receiving data identifying:
the plurality of different entity types; and
for each of the plurality of different entity types, at least one attribute associated with the each of the plurality of different entity types; and
wherein the attribute data presented in the user interface is attribute data relating to the at least one attribute associated with the each of the plurality of different entity types.

8. A method for presenting data, comprising:
presenting, by a computing device, in a user interface, entity labels identifying a plurality of different entity types modeled in a database;
receiving, by the computing device, input identifying one or more selected entity types of the plurality of entity types;
accessing, by the computing device, a plurality of entity instance relationship sets, each entity instance relationship set identifying a relationship between entity instances of at least two different entity types of the plurality of different entity types; and
presenting, in the user interface, from only those entity instance relationship sets that identify a relationship between entity instances of the one or more selected entity types, attribute data of the entity instances identified in each such entity instance relationship set, wherein attribute data for each unique relationship between entity instances of the one or more selected entity types is presented only once.

9. The method of claim 8, wherein each entity instance relationship set identifies a relationship between entity instances of at least three different entity types of the plurality of different entity types.

10. The method of claim 8, wherein each entity instance relationship set comprises entity instance identifiers, each of which uniquely identifies one of the entity instances of the at least two different entity types.

11. The method of claim 8, wherein the plurality of entity instance relationship sets comprises multiple entity instance relationship sets that identify a same relationship between the entity instances of the at least two different entity types of the plurality of different entity types.

12. The method of claim 8, further comprising:
prior to presenting, in the user interface, the entity labels identifying the plurality of different entity types modeled in the database, receiving data identifying:
the plurality of different entity types; and
for each of the plurality of different entity types, at least one attribute associated with the each of the plurality of different entity types; and
wherein the attribute data presented in the user interface is attribute data relating to the at least one attribute associated with the each of the plurality of different entity types.

13. A computing device comprising:
a communication interface adapted to communicate with a network; and
a control system comprising a processor and coupled to the communication interface, and adapted to:
present in a user interface entity labels identifying a plurality of different entity types modeled in a database;
receive input identifying one or more selected entity types of the plurality of different entity types;
access a plurality of entity instance relationship sets, each entity instance relationship set identifying a relationship between entity instances of at least two different entity types of the plurality of different entity types; and
present in the user interface from only those entity instance relationship sets that identify a relationship between entity instances of the one or more selected entity types attribute data of the entity instances identified in each such entity instance relationship set, wherein attribute data for each unique relationship between the entity instances of the one or more selected entity types is presented only once.

14. The computing device of claim 13, wherein each entity instance relationship set identifies a relationship between entity instances of at least three different entity types of the plurality of different entity types.

15. The computing device of claim 13, wherein each entity instance relationship set comprises entity instance identifiers, each of which uniquely identifies one of the entity instances of the at least two different entity types.

16. The computing device of claim 13, wherein the plurality of entity instance relationship sets comprises multiple entity instance relationship sets that identify a same relationship between entity instances of the at least two different entity types of the plurality of different entity types.

17. The computing device of claim 13, wherein the control system is further adapted to:
prior to presenting, in the user interface, the entity labels identifying the plurality of different entity types modeled in the database, receive data identifying:
the plurality of different entity types; and
for each of the plurality of different entity types, at least one attribute associated with the each of the plurality of different entity types; and
wherein the attribute data presented in the user interface is attribute data relating to the at least one attribute associated with the each of the plurality of different entity types.

18. A computer program product for presenting data, the computer program product stored on a non-transitory computer-readable storage medium and including instructions configured to cause a processor to carry out the steps of:
presenting in a user interface entity labels identifying a plurality of different entity types modeled in a database;
receiving input identifying one or more selected entity types of the plurality of entity types;
accessing a plurality of entity instance relationship sets, each entity instance relationship set identifying a relationship between entity instances of at least two different entity types of the plurality of different entity types;
selecting, from the plurality of entity instance relationship sets, only those entity instance relationship sets that identify a relationship between entity instances of the one or more selected entity types to form a subset of entity instance relationship sets, wherein only a single entity instance relationship set is selected for each different identified relationship; and
for each entity instance relationship set in the subset, presenting, in the user interface, attribute data from each of the entity instances identified as having a relationship in the each entity instance relationship set.

19. The computer program product of claim 18, wherein the plurality of entity instance relationship sets comprises multiple entity instance relationship sets that identify a same relationship between entity instances of the at least two different entity types of the plurality of different entity types.

20. The computer program product of claim 18, wherein the instructions are further configured to cause the processor to carry out the steps of:
prior to presenting, in the user interface, the entity labels identifying the plurality of different entity types modeled in the database, receiving data identifying:
the plurality of different entity types; and
for each of the plurality of different entity types, at least one attribute associated with the each of the plurality of different entity types; and
wherein the attribute data presented in the user interface is attribute data relating to the at least one attribute associated with the each of the plurality of different entity types.
